(19) United States
(12) Patent Application Publication
(10) Pub. No.: US 2018/0202112 A1
(43) Pub. Date: Jul. 19, 2018

(54) DETERMINING STRENGTH OF WOOD FIBERBOARD

(71) Applicant: Siempelkamp Maschinen- und Anlagenbau GmbH, Krefeld (DE)

(72) Inventors: Jochem BERNS, Grefrath (DE); Lars KLOESER, Krefeld (DE)

(21) Appl. No.: 15/851,818

(22) Filed: Dec. 22, 2017

(30) Foreign Application Priority Data
Dec. 23, 2016 (DE) 102016015519.1

(51) Int. Cl. D21J 1/20; D21J 1/10; G01N 3/10

(52) U.S. Cl. CPC D21J 1/20; D21J 1/10; G01N 2203/0096; G01N 2203/0019; G01N 3/10

(57) ABSTRACT

Wood-fiber insulation board is pressed to a uniform thickness and continuously advanced in a horizontal travel direction on a conveyor prior to subdivision into individual panels. The strength of the wood-fiber insulation board is determined by first pressing with an actuator a contact element downward at an actual pressure on a subregion of the advancing wood-fiber insulation board so as produce an actual deformation of the wood-fiber insulation board of between 1% to 7% of its thickness. Then a force sensor determines the actual pressure applied by the contact element to the board that produces the actual deformation and this the determined pressure and the actual deformation are transmitted to a central processor that extrapolates to a standardized deformation based on the determined pressure and actual deformation.

### FIELD OF THE INVENTION

The present invention relates to a method of and apparatus for determining the strength of a wood-fiber insulation board.

### BACKGROUND OF THE INVENTION

It is known to determine the strength of wood-fiber insulation boards by pressing a contact element on a portion of a wood-fiber insulation board to produce a relative deformation of the wood-fiber insulation board over a predefined distance and thereby determine the pressure at at least one compression point.

Quality-determining strength values of wood-fiber insulation boards are usually determined by destructive material testing after sampling from current production. In wood-fiber insulation boards, compressive strength is an important quality characteristic. It is determined, for example, by compressing a square cut-out piece measuring 100 mm×100 mm at a defined speed with a stamp having a larger footprint. For this purpose, a pressure/compression diagram is set up.

While the curve generally has a progressive profile in the beginning, this is followed by a short linear portion and then suddenly a degressive profile. As a result of this degression, the compressive displacement of the wood-fiber insulation board is greater that it would be according to a linear characteristic, that is, in reality, less compressive stress has to be applied for the same amount of buckling than would be required according to a linear curve like in the second portion.

The linear region (between the progressive and degressive curve profile) often lies in the range from 1% to 7% relative deformation. Nevertheless, there is a consensus to use the extended linear profile in determining compressive strength value, even though a standardized compressive strain or displacement of 10% of the board thickness is usually used as the basis for the compressive stress value. The German and European standard EN 826 must be taken very especially into account here.

This customary procedure of determining the compressive strength in the laboratory following manufacture makes direct or on-the-fly monitoring impossible. Corrections can only be made to the production process after the compressive strength is determined in the laboratory.

### OBJECTS OF THE INVENTION

It is therefore an object of the present invention to provide an improved system for determining strength of wood fiberboard.

Another object is the provision of such an improved system for determining strength of wood fiberboard that overcomes the above-given disadvantages, in particular that largely eliminates the drawbacks of delayed reactive adjustments.

### SUMMARY OF THE INVENTION

In the manufacture of wood-fiber insulation board where the board is pressed to a uniform thickness and the pressed board is continuously advanced in a horizontal travel direction on a conveyor prior to subdivision into individual panels, a method of determining the strength of the wood-fiber insulation board has according to the invention the steps of pressing with an actuator a contact element downward at an actual pressure on a subregion of the advancing wood-fiber insulation board so as produce an actual deformation of the wood-fiber insulation board of between 1% to 7% of its thickness, determining by a force sensor the actual pressure applied by the contact element to the board that produces the actual deformation, transmitting the determined pressure and the actual deformation to a central processor, and with the central processor, extrapolating to a standardized deformation based on the determined pressure and the actual deformation.

In other words, the object is achieved in that the contact element is placed onto the wood-fiber insulation board above a conveyor for the wood-fiber insulation board after a continuous board press, the contact element is pressed by an actuator into the wood-fiber insulation board to between 1% and 7% of the wood-fiber insulation board thickness, the force or pressure required for this is detected by at least one sensor, and the force or pressure and displacement data are forwarded to a central processor, where an extrapolation to a standardized displacement and the theoretically required pressure therefor is performed.

The invention is based on recognition of the fact that the linear pressure-displacement range between 1 and 7% compressive displacement can be exploited for the invention. This range is still very largely elastic, so the method according to the invention does not leave any traces on the manufactured wood-fiber insulation board. Nevertheless, exactly the same value—with over 95% accuracy—is obtained for the compressive strength, which corresponds to the compressive stress at 10% compressive strain or displacement, as would be determined afterward in the laboratory. This value determined in the process downstream of the continuous press enables the plant operator to respond immediately by influencing the distribution of a mat of chippings to be pressed, the supply of binders, or the pressures and temperatures in the upstream continuous press.

Various types of construction can be used as an “actuator” in the apparatus according to the invention. Pneumatically driven double-acting cylinders are preferred.

However, all other types of servomotor or spindle drive are also suitable for carrying out the invention, provided that they execute a vertical movement toward the wood-fiber insulation board and can exert the pressure that is required for compression. Here, the term “force sensor” also includes all sensors that detect pressure.

As a whole, the invention makes a highly simplified and, particularly, time-saving procedure possible in determining the compressive strength of a wood-fiber insulation board.

Preferably, the wood-fiber insulation board is compressed by 1.5 to 3% of its thickness. In this range of 1.5 to 3% compression, one can be certain of also being in a linear dependency range. The extrapolation to a value of 10% compression, for example, is then certainly linear. The compressive strength is thus determined through a correlation to the modulus of compression in the elastic range.

The displacement of the contact element is advantageously detected by a displacement sensor.

The wood-fiber insulation boards in question have a thickness of 20 to 240 mm. While one generally knows how thick the produced wood-fiber insulation board is and can therefore also set the displacement to 1 to 7% compression using a stop, it is advantageous if the distance traveled by the contact element can be recorded with precision. It can then be more easily adapted to changed conditions by controlling the actuator as needed. This occurs if the operator of the plant would like to manufacture wood-fiber insulation boards of different thicknesses,

Furthermore, it is preferred that the detected traveled distance and the required pressure value be forwarded to the central processor.

This information enables the processor to easily determine the pressure value directly using the method established in EN 826 and store it as necessary. If the central processor is coupled with the system control, corrections to the process parameters can be initiated and regulated immediately in the event of changes in the determined compressive strength value.

It is advantageous to use a skid with a defined width as a contact element.

From the outset, such a skid has a defined surface area that is pressed into the wood-fiber insulation board by the actuator. This simplifies the conversion of the force applied by the actuator and the force detected with its force sensor into a compressive stress.

Alternatively, however, it is also advantageous if a wheel is used as a contact element.

A wheel does not slide over the wood fiber mat, but rather rolls over it. This diminishes the risk of marks or depressions being left on the wood-fiber insulation board. In this case, however, more complicated calculations are required in a central processor in order to determine the extrapolated compressive stress, for example in consideration of the Hertzian contact stress. Such programming does not pose a problem for a calculation specialist.

Preferably, the contact element only bears downward with its own weight on the wood-fiber insulation board before activation of the actuator.

This provides a reference point with respect to the impression or compression depth. The displacement sent from the displacement sensor to the central processor thus enables the zero point for the pressure measurement and compression of the wood-fiber insulation board to be established.

Unfortunately, a mark cannot be avoided in some wood-fiber insulation boards that are made of certain materials. In that case, it is advantageous to locate the area of measurement in question where the wood-fiber insulation board is to be cut afterward.

A measuring point is therefore selected upstream of where a cut is required anyway immediately to the cutting or sawing during board production, and cutting or sawing is performed immediately downstream of a mark or impression caused by the measurement in order to enable the area to be cut out.

It is especially preferred if the measurement is performed cyclically on the basis of a time interval or a certain production quantity.

In this way, the above-described process parameters can be checked and corrected on an ongoing basis and the quality of the wood-fiber insulation boards continuously monitored.

As regards the apparatus for carrying out the method of the invention for determining the strength of wood-fiber insulation boards, with a relative deformation of the wood-fiber insulation board being produced over a predefined distance, and with it being possible for the pressure to be determined at at least one compression point, the apparatus is arranged downstream of a continuous press for manufacturing wood-fiber insulation boards over a conveyor for the wood-fiber insulation board.

This enables the compressive strength value to be determined immediately after the manufacture of the wood-fiber insulation board.

Preferably, the contact element has a defined width in the range from 100 to 250 mm.

This approximates the conditions of testing that has been carried out subsequently in the laboratory until now, and such widths require actuators whose forces are still easily managed.

Preferably, the apparatus has a displacement sensor that can determine depth of penetration.

Since the aim is preferably to compress the board by 1.5 to 3% of its thickness, it is especially easy to determine the penetration depth of the contact element.

The apparatus advantageously has a force sensor for detecting the force for a defined penetration depth of the contact element into the wood-fiber insulation board.

When the measurement signal for displacement and force is forwarded to a central processor, it is possible to calculate the extrapolated compressive stress value for a 10% relative deformation of the wood-fiber insulation board, for example.

### BRIEF DESCRIPTION OF THE DRAWING

The above and other objects, features, and advantages will become more readily apparent from the following description, reference being made to the accompanying drawing in which:

FIG. 1 is a large-scale schematic side view of an apparatus according to the invention for determining the strength of wood-fiber insulation board;

FIG. 2 is a view like FIG. 1 of a variation on the system of FIG. 1;

FIG. 3 is a graph comparing pressure as a function of compressive displacement; and

FIG. 4 is a schematic small-scale top view of a portion of an installation for manufacturing wood-fiber insulation board.

### SPECIFIC DESCRIPTION OF THE INVENTION

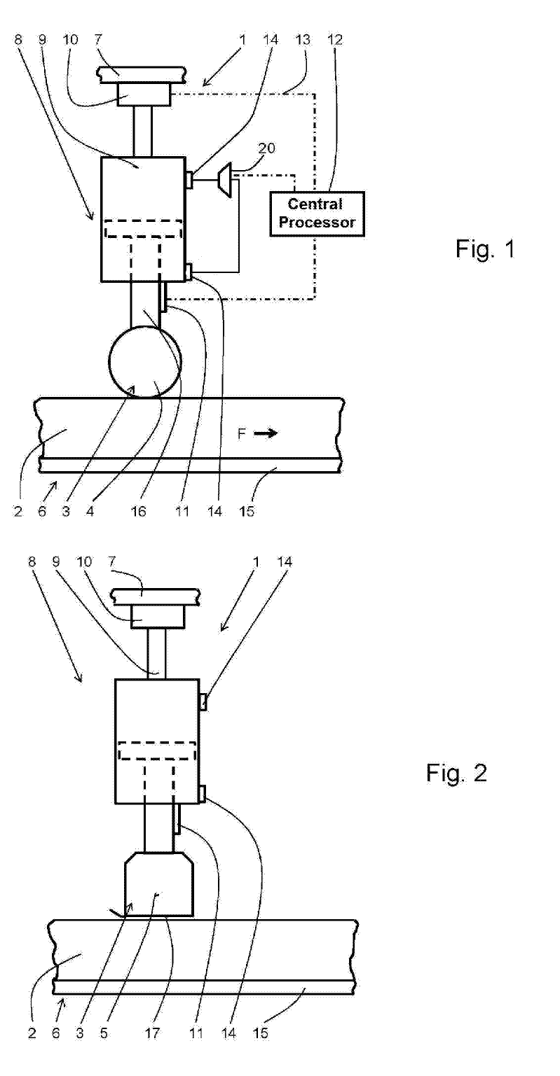

FIG. 1 shows the apparatus 1 for determining the strength of wood-fiber insulation board 2 that 2 is transported on a conveyor 6, here for example a conveyor belt 15. The view shows part of an installation for manufacturing wood-fiber insulation boards moving in a horizontal travel direction F downstream of a continuous press 18 (FIG. 4) for the raw material scattered onto a molding belt and upstream of a sawing device 19 (FIG. 4) for cutting the final dimensions of the finished wood-fiber insulation boards. For the sake of clarity, the upstream press 18 and the downstream cutting station 19 are part of a basic manufacturing process for wood-fiber insulation boards as described in U.S. Pat. No. 8,394,303 that is herewith incorporated reference. The schematic top view of FIG. 4 shows that the continuous press 18 is followed by the apparatus 1 for determining the compressive strength, after which the wood-fiber insulation board is later broken down into individual rectangular boards by the diagonal saw 19. The apparatus 1 for determining the compressive strength can be moved transverse horizontally transverse to the direction F over the width of the wood-fiber insulation board so that measurements can be taken in different regions spaced along the width of the workpiece board 2.

The apparatus 1 itself is fastened to a stationary mount 7 above the conveyor belt 15 and above the strand forming the wood-fiber insulation board 2 that is coming out of the continuous press 18 and can also be optionally moved thereon over the width of the wood fiber board 2. In this embodiment, it comprises—as the operative actuator 8—at least one pneumatic double-acting cylinder 9 whose front and rear compartments are supplied with compressed air via pressure ports 14 from a reversible pump 20. A piston rod 16 of this pneumatic double-acting cylinder 9 can vertically move and downwardly press a contact element 3 against the wood-fiber insulation board 2. A width of about 100 to 250 mm is recommended for the contact element, although this is not binding for the invention. In the embodiment according to FIG. 1, the contact element 3 is a rotatable disk 4 that bears downward on the wood-fiber insulation board 2 and can be pressed downward by the actuator 8. It is shown in the position in which the wheel 4 is just slightly touching the wood-fiber board (for example, only due by the force 9 of gravity caused by the weight of the piston rod and wheel) and thus establishes the reference value, i.e. the zero position, for measurement of the depth of penetration into the wood-fiber insulation board during compression.

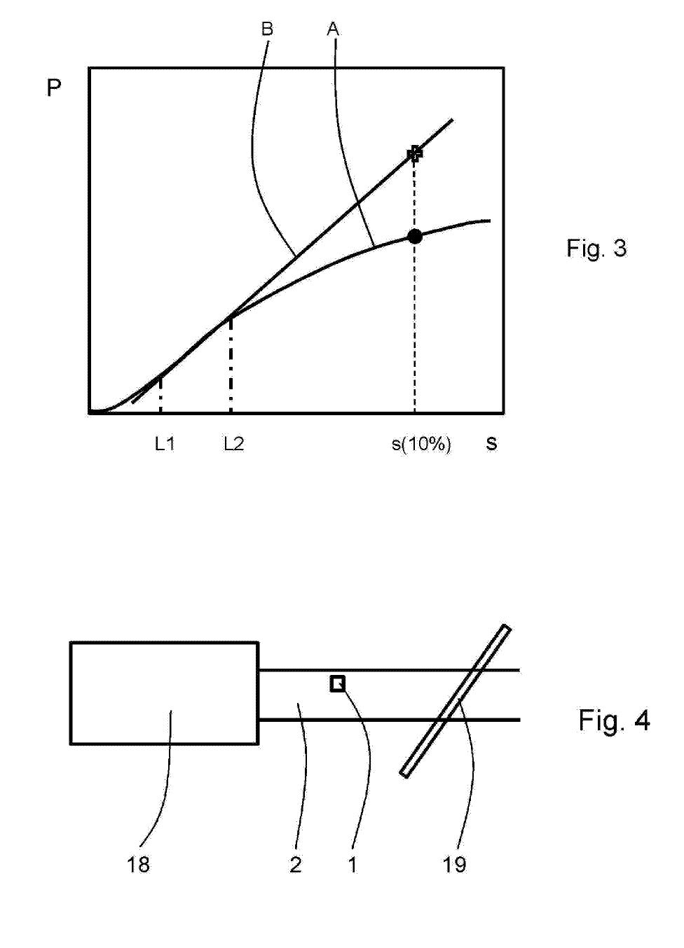

A displacement sensor 11 and a force sensor 10 are connected to the pneumatic double-acting cylinder 9. Data lines 13 go from these two measuring devices to a central processor 12. The measurement process itself is described in connection with FIG. 3.

FIG. 2 shows a slight variant of FIG. 1. Here, only one other contact element 3 is provided in the form of a skid 5 so that it therefore has a wider and defined contact surface 17.

Finally, FIG. 3 explains the measurement process for determining the compressive strength of the wood-fiber insulation board. According to standard EN 826, the pressure value for producing 10% relative deformation is set as the strength value. In the pressure-compressive displacement diagram of FIG. 3, curve A shows that the pressure behaves progressively at first in relation to the compressive displacement s, running approximately linear for a bit, and finally dropping off degressively. The boundaries of the linear area are shown in FIG. 3 by the markings L1 and L2. If one takes the value of a 10% relative deformation of the wood fiber board thickness s(10%) as prescribed by EN 826, then it becomes evident that the pressure associated therewith (shown by a dot) is lower than that which results from the extension of the linearized curve B. According to EN 826, however, the pressure value that is shown above the dot by a cross in the figure is the one that must be determined.

According to the invention, it was recognized that, in order to determine the linearized curve B arithmetically, the wood-fiber insulation board 2 need only be compressed within the range in which the wood-fiber insulation board behaves elastically. What is needed is the gradient in the area between points L1 and L2. To this end, however, it is sufficient to compress the wood-fiber insulation board preferably 1.5 to 3%, but at least in the compressive displacement range from 1 to 7% of the board thickness and to measure or calculate the force or pressure required for that. The second consideration is to no longer carry out the pressing procedure on a board specimen in the laboratory, but instead to determine the relevant data on the fly during production and, by virtue of the fact that compression is performed only within the elastic range of the wood-fiber insulation board, to not leave behind any markings or impressions that are subsequently visible.

The data, the compressive displacement, and the required force or required pressure that are preferably detected between 1.5 and 3% compressive displacement are forwarded to a central processor 12 that then extrapolates the point that is marked with a cross in FIG. 3. The compressive strength value of the wood-fiber insulation board can thus be determined in a quick and uncomplicated manner.

We claim:

1. In the manufacture of wood-fiber insulation board where the board is pressed to a uniform thickness and the pressed board is continuously advanced in a horizontal travel direction on a conveyor prior to subdivision into individual panels, a method of determining the strength of the wood-fiber insulation board comprising the steps of:
pressing with an actuator a contact element downward at an actual pressure on a subregion of the advancing wood-fiber insulation board so as produce an actual deformation of the wood-fiber insulation board of between 1% to 7% of its thickness;
determining by a force sensor the actual pressure applied by the contact element to the board that produces the actual deformation;
transmitting the determined pressure and the actual deformation to a central processor; and
with the central processor, extrapolating to a standardized deformation based on the determined pressure and the actual deformation.

2. The method defined in claim 1, wherein the wood-fiber insulation board is vertically compressed by 1.5 to 3% of its thickness by the contact element.

3. The method defined in claim 1, further comprising the step of:
detecting a vertical displacement of the contact element by a displacement sensor.

4. The method defined in claim 3, further comprising the step of:
transmitting the detected displacement with the pressure and actual deformation to the central processor and,
with the central processor, extrapolating to the standard deformation based on the determined pressure, the actual deformation and the detected displacement.

5. The method defined in claim 1, wherein the contact element is a skid having a defined width.

6. The method defined in claim 1, wherein the contact element is a wheel rolled in the direction on the board.

7. The method defined in claim 1, further comprising the step, before pressing the contact element down with the actuator, of:
setting the contact element on the board to bear thereon only with its own weight.

8. The method defined in claim 1, further comprising the step of:
locating where the contact element compresses the board at a location that can subsequently be cut from the board.

9. The method defined in claim 1, wherein the pressure determination is performed cyclically on the basis of a time interval or a certain production quantity.

10. In the manufacture of wood-fiber insulation board where the board is pressed to a uniform thickness and the pressed board is continuously advanced in a horizontal travel direction on a conveyor prior to subdivision into individual panels, an apparatus for determining the strength of the wood-fiber insulation board, the apparatus comprising:
a vertically shiftable contact element;
actuator means for pressing the contact element downward at an actual pressure on a subregion of the advancing wood-fiber insulation board so as produce an actual deformation of the wood-fiber insulation board of between 1% to 7% of its thickness;
a force sensor for determining the actual pressure applied by the contact element to the board that produces the actual deformation;
a central processor; and
means for transmitting the determined pressure and the actual deformation to the central processor, the central processor extrapolating to a standardized deformation based on the determined pressure and the actual deformation.

11. The apparatus defined in claim 10, wherein the contact element has a defined width in the range from 100 to 250 mm.

12. The apparatus defined in claim 11, further comprising:
a displacement sensor associated with the contact element.

13. The apparatus defined in claim 12, wherein the actual deformation is a predefined depth of penetration of the contact element into the wood-fiber insulation board.
